(19) United States
(12) Patent Application Publication
(10) Pub. No.: US 2007/0210936 A1
(43) Pub. Date: Sep. 13, 2007

(54) System and method for arrival alerts

(76) Inventor: Hilton Nicholson, Eden Prairie, MN (US)

Correspondence Address: NIELDS & LEMACK, 176 EAST MAIN STREET, SUITE 7, WESTBORO, MA, 01581, US

(21) Appl. No.: 11/699,956

(22) Filed: Jan. 29, 2007

Related U.S. Application Data
(60) Provisional application No. 60/763,847, filed on Jan. 31, 2006.

(51) Int. Cl. G08G 1/123

(52) U.S. Cl. 340/988

(57) ABSTRACT

A system and method for generating predictive alerts, such as imminent arrival alerts is disclosed. This invention utilizes the location determination capabilities of GPS-enabled phones and other devices to overcome a common problem: waiting. The capability to determine the position of an object, such as a vehicle, in real time, is coupled with information about its projected route to create predictive alerts. For example, knowing a bus route and its present location, the algorithms of the present invention predict when that bus will arrive at a subsequent stop. Having made this determination, bus riders, who board at this subsequent stop, are alerted to the imminent arrival of the bus at their bus stop. Similar algorithms can be employed for other types of vehicles, such as delivery or repair trucks, and airport transportation.

This application claims priority of U.S. Provisional Application Ser. No. 60/763,847, filed Jan. 31, 2006, the disclosure of which is incorporated herein by reference.

### BACKGROUND OF THE INVENTION

With the advent of portable, low cost Global Positioning Systems (GPS), the ability to track people and assets has been significantly enhanced, and the number of applications exploiting this ability has exploded.

The Global Positioning System includes a plurality of satellites that broadcast radio signals to enable a receiver to determine its location. The satellites transmit position and time signals to a receiver positioned in a vehicle, for example. The receiver then processes this information to calculate its distance from a particular satellite by knowing the location of the satellite and calculating the time elapsed between the transmitted and received signal. This process is repeated so distances from more than one satellite are computed simultaneously, whereupon the location of the vehicle can be ascertained. The location determined by the receiver is in terms of the latitude and longitude of the place. The latitude and longitude obtained from the receiver, together with a map of the area, allows for the location of the vehicle to be identified by street name or town name, for example.

For example, one application allows a GPS transmitter to be placed within an automobile. The location of the vehicle can then be monitored remotely, in real time. This monitoring can be displayed via several types of devices, having a variety of user interfaces, including portable cell phones and computer browsers. This application is marketed and directed toward teenaged drivers, although it is applicable to any driver. In addition to tracking the location of the automobile, the application offers advanced features. One such feature is the monitoring of the vehicle's speed, which is determined by measuring its change in position over a period of time. As a further enhancement, a maximum speed can be established, and if the automobile exceeds that speed, a remote person receives an alert, such as via a text message on their portable telephone. Another feature of this application is the ability to monitor the location of the vehicle and define a geofence. A geofence is a user-defined area within which the automobile must remain. For example, this geofence could be defined as a specific radius from the driver's home, such as 50 miles. Should the automobile exit this geofence, the remote person could be alerted instantaneously, such as via text message.

In one embodiment, known as DriveOK, a unit, comprising a GPS transponder and portable phone is placed in the vehicle of interest. This unit receives its location from satellites and stores speed, direction and position information. When queried, the unit transmits this data onto the cellular phone network. The information is then routed to the remote user's portable phone, the remote user's email account, and/or is made available via a web browser.

This concept has also been applied to tracking the location of pets. In one embodiment, a pet collar incorporates a GPS transponder, thereby allowing a remote user, such as the pet owner, to track the location of the pet at all times. As with the automobile application, this application also permits the establishment of a geofence, with a similar alert mechanism should the pet exit the defined area.

Telecommunications companies, including such companies as Nextel/Sprint, have also become involved in this burgeoning industry, offering portable cellular phones with GPS capability. In conjunction with these phones, these companies offer accompanying services, utilizing the ability to track the location of a GPS enabled phone remotely. These applications allow instant location determination of personnel, trucking fleets, equipment, and other assets.

Another application allows the GPS-enabled phone user to request and receive directions from their current location to their desired destination. For example, an extension of the popular website, Mapquest.com, known as Mapquest® Find Me, works in conjunction with GPS-enabled phones to offer a variety of capabilities. These include automatic location reporting, which allows the phone user to view their current location without manually entering an address; a people locator, which allows the phone user to view the current location of family, friends and co-workers with their permission; a point of interest locator, which allows the phone user to find nearby banks, theaters, restaurants, hotels and more; and directional guidance, which allows the phone user to receive and view turn-by-turn text directions to their destination on their phone.

Almost all of these applications can be divided into two broad categories. The first is real time location determination. This type of application allows the remote user to determine the location of an object in real time, where the object can be, for example, an automobile, a pet, a package, a fleet of trucks, or personnel. Most of these applications provide results over a wireless communications network via a web browser, or a text message sent to a portable phone. The second type of application is route guidance, where the user of the GPS-enabled phone uses it to navigate from his current location to the desired destination. In these applications, the results are provided on the GPS-enabled phone.

Few of these applications, however, use location to predict future events. There are a number of common everyday occurrences, in which people spend valuable time waiting for the arrival of a particular person, vehicle or other object of interest. Several examples of this include children waiting for school busses, people waiting at bus stops for metro busses, people waiting at their homes for delivery vehicles, and people waiting in lobbies and curbside for taxis and airport limousines. In all of these cases, waiting time can be reduced by utilizing the vehicle's location information, as determined by a GPS device, in conjunction with additional information.

### SUMMARY

The present invention utilizes the location determination capabilities of GPS-enabled phones and other devices to overcome a common problem: idle waiting. A system and method are provided for generating predictive alerts, such as imminent arrival alerts. The capability to determine the position of an object, such as a vehicle, in real time, together with information about its projected route are used to create and transmit predictive alerts. For example, knowing a bus route and its present location, the present invention predicts when that bus will arrive at a certain bus stop. Having made this determination, bus riders, who board at this certain bus stop, are alerted to the imminent arrival of the bus at their bus stop. Similarly, this invention can be employed for other types of objects or vehicles, such as delivery or repair trucks, and airport transportation.

The system of the present invention can include a receiver configured to receive position signals from a satellite positioning system, a transmitter for transmitting real time locations over a wireless communications network, a computer processor configured to receive the transmitted locations and having access to stored data containing user specific information, and means for sending a signal to a user interface over a wireless communications network.

### BRIEF DESCRIPTION OF THE DRAWINGS

FIG. 1 is a flowchart illustrating the operation of the present invention.

### DETAILED DESCRIPTION OF THE INVENTION

There are many applications in which people are forced to wait for the arrival of a particular vehicle or object of interest. One very common example of this involves students waiting for their school bus to arrive. While these school buses operate on a nearly consistent schedule, there are occasions when the bus arrives early or late. At times, this irregularity can be problematic. For example, the early arrival of the bus may result in school children missing their bus, thereby forcing them to seek alternative modes of transportation to school, such as rides from their parents or caretakers. The late arrival of the bus brings other problems and potential perils. At times, weather conditions can be severe; with bitterly cold temperatures and snow in the northern states, or extremely hot temperatures in the southern states. Prolonged exposure to these conditions can be detrimental and ill-advised for children. Another unfortunate peril is the criminal element. Recently, there have been numerous abductions that have occurred at school bus stops. The tardy arrival of the bus increases the amount of time that children are in this unsupervised environment and may subject them to an increased risk of harm or foul play.

Similar issues exist at metro bus stops, where potential riders may be forced to wait at an outdoor bus stop for significant amounts of time for a delayed bus. Since some of those who patronize busses are elderly and infirm, many of the risks articulated above with respect to school children are also applicable to these riders.

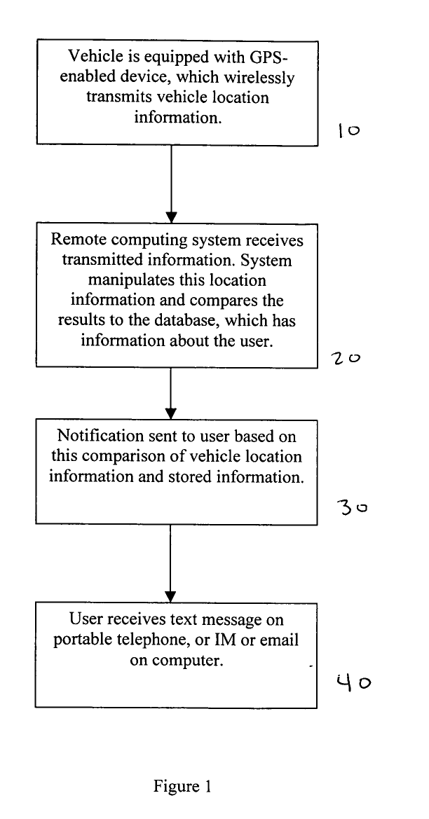

FIG. 1 shows a flowchart illustrating steps carried out to implement the present invention. In the preferred embodiment, as shown in Box 10, the vehicle, such as a school bus, is equipped with a GPS-enabled device, such as a portable telephone. This device includes a GPS receiver, and a transmitter for transmitting information, preferably wirelessly, to a computer server, preferably at regular intervals. These regular intervals may be based on elapsed time (i.e. every 30 seconds) or distance traveled (i.e. every ¼ mile). The server preferably includes a processor and storage capabilities. The device preferably transmits the current location of the vehicle and some unique identifying information, such as, but not limited to, a unique vehicle ID and/or bus route number. This identifying information is used by the server to determine which entries in a central database are related to this transmission. For example, the database may contain fields including the student's name, and their assigned bus route. When a wireless transmission is received from a particular bus, the identifying information is used to parse the database to determine the specific students who are served by this bus. The database may also contain information associated with each bus, such as its scheduled bus stops. Therefore, when a wireless transmission is received, the server can determine which bus it originated from. Based on that, it can determine whether the bus is currently at a scheduled bus stop. Furthermore, it can then determine whether the conditions for notification have been satisfied.

As shown in Box 20, a computer server is remotely located and receives the transmitted information from the GPS-enabled device onboard the school bus. Preferably resident on the computer server is a database containing relevant user information, such as student names, addresses and phone numbers, and an association between each student, address and/or phone number with a designated bus stop. The association can simply be the matching of a student, address or phone number with a designated bus stop, or can be the time or distance necessary for the student to travel from his residence to a designated bus stop. In other embodiment, the database is physically separate from the server, although the server has access to it, such as via a network, or the internet. The computer system uses the present location of the vehicle, as transmitted by the GPS-enabled device, in conjunction with the information in the database to determine which students should be alerted.

In one embodiment, students are alerted when the bus reaches a position which is less than a predetermined distance, such as 1 mile, from their house or their designated bus stop. This embodiment can utilize the concept of geofences, but rather than using geofences to detect a vehicle's exit from the defined area, the system serves to alert the user upon a vehicle's entry into the geofence. Alternatively, the geofence can be based on the location of the student's designated bus stop, rather than the location of the student's residence. In yet another embodiment, rather than creating a geofence around the designated bus stop, as described above, a geofence can be created around a preceding bus stop. In this way, the student is alerted when the bus exits the geofence defined around a previous bus stop.

The following serves to illustrate this embodiment. The server receives the vehicle location information. It then determines the distance from the vehicle's current location to each student's designated bus stop. This determination is well known to one skilled in the art. The server then compares this calculated distance to an entry in the database, which represents the distance from the user's bus stop at which he or she wished to be alerted. As an example, the user may specify that he wishes to be alerted when the bus is within 1 mile of the designated bus stop. The server continuously receives real time vehicle location information and computes the distance from the bus to the designated bus stop. When this distance drops below 1 mile, an alert is sent to the user.

In a second embodiment, the database also retains or has access to information about the route and specific stops made by the bus. The system can then determine, based on the transmitted location, when the vehicle has reached a particular bus stop in the route. It can then send alerts to students whose designated bus stop is the next bus stop in the route. Optionally, if that notification period is insufficient, alerts can be sent to students whose designated bus stop is two or more stops after the particular bus stop that has been reached.

For example, the user specifies that he wishes to be alerted when the bus has reached a specific preceding bus stop. The server, having received the routes for all school busses, is able to determine the coordinates of that specified bus stop. It then compares the transmitted vehicle location to the coordinates of the specified bus stop and sends an alert when a match is found.

In a third embodiment, the database also retains information related to time based notification. For example, a user may wish to be notified 5 minutes before the school bus reaches the designated bus stop. Using the current location of the school bus, together with its average and instantaneous speed, an estimate of when the school bus will reach the designated bus stop can be calculated. Whether this value is less than or equal to the request notification period, an alert is sent to the user.

In one implementation, the user specifies a time interval, such as 5 minutes, before the bus reaches the bus stop. As above, the server continuously receives the vehicle location information. It can then calculate the instantaneous speed by comparing this transmission to the previous one. It can also calculate average speed by comparing a larger number of previous transmissions. If desired, the server can also estimate the time spent at each bus stop and incorporate this value into the calculation. This estimate can be an assumption, or can be based on data collected previously for each bus stop. It then determines the distance between the current location and the designated bus stop. Based on the bus speed, and the number of bus stops between its current location and the designated bus stop, an estimate of the time required to reach the designated bus stop can be made. This calculated value is then compared to the user supplied notification parameter.

The correlation between a student and his or her designated or frequented bus stop can be determined in one of several ways. In one embodiment, the determination is based solely on the geographic location of the student's house and the surrounding bus stops. In this case, the system assumes that the student frequents the bus stop closest to their house. In a second embodiment, the information as to what bus stops each student frequents is inputted and stored in the database.

In the preferred embodiment of this invention, users who wish to participate in this school bus alert program would be required to supply certain data that set forth the conditions for an alert or notification to be sent. Relevant data includes, but is not limited to, student's name, student's address, student's school, student's bus number, student's preferred or designated bus stop, and the location(s) where the alert should be sent, such as a phone number and/or e-mail address and/or instant message screen name. Additional, supplemental information, such as the requested interval from notification to arrival of the school bus, and whether an alert is to be sent when the student returns home at the end of the school day (e.g., when the bus reaches a designated bus stop to drop a student off), could also be included in the database. For example, if it takes a student 6 minutes to walk to the bus stop, the interval from notification to bus arrival for that student should be greater than 6 minutes.

Having determined, as described above, which students to notify, the server then notifies the student, as indicated in Box 30. As shown in Box 40, this notification is typically in the form of a text message to a mobile phone, although other forms of notification, such as prerecorded or automated messages to landlines and/or mobile phones, instant messages or email alerts, are within the scope of the invention.

In the expected scenario, the students would depart for their respective bus stop after having received the notification, arriving just in time to board the arriving school bus.

While the above example utilizes the concept of school children boarding a school bus, the invention is not so limited. As mentioned above, the same architecture could also be employed on metro, or city busses. The scheme is also applicable to other forms of mass and public transportation, such as subways and trains. The present invention may not be as beneficial in these scenarios since these types of vehicles typically adhere much more closely to their published schedules.

The present invention also includes the ability for users to adjust previously programmed alert conditions using their mobile phone, telephone or the web. In one embodiment, an application allows the use to vary the pre-programmed arrival alert interval using a simple +/− scheme, such as via radio buttons or menu options. In another embodiment, the application allows the user to program a series of dates during which alerts should not be sent (as in the case of a vacation or illness). Finally, the application can allow the user to completely modify their notification entry. For example, if a person works different shifts, they may be required to utilize different busses for each specific shift. This may require them to reprogram the notification criteria each time their shift changes.

Other applications for the present invention include notification of arrival time of delivery and service vehicles. Currently, when one is having merchandise, such as furniture or electronics, delivered, that person is provided with a delivery time window. These windows can be as wide as 4-6 hours, typically forcing a person to stay at home all day waiting for the delivery. This scenario is also common with respect to repair personnel, such as plumbers, cable, phone and utilities servicemen, and electricians. Typically, a time window is given during which time the repairperson is expected to arrive. Similar to the delivery scenario, a person is often forced to wait at home all day for the required personnel to arrive.

In these cases, imminent arrival alert would be very beneficial in minimizing the amount of time that a person would be required to remain at home waiting for the delivery or repairman arrival. There are several different algorithms and display systems which can be employed for these scenarios. In one embodiment, the person is notified when the delivery or repairman has reached the stop scheduled just prior to that person's stop. In other words, if the delivery service has eight stops and a particular person is the fifth scheduled stop, that person would be alerted when the delivery truck has reached its fourth scheduled stop, and/or when the delivery truck is leaving its fourth scheduled stop. This model is very similar to that described above with respect to school buses. Alternatively, in another embodiment, the person can be notified when the delivery vehicle is within a specified distance from the person's home, or when the delivery vehicle is a certain time away from the person's home, as calculated based on the location of the vehicle and the time necessary to travel to the home. This specified distance or time may be a fixed value, such as 10 miles or 10 minutes, or may be supplied by the awaiting person, based on criteria such as the distance the person has to travel or the time necessary to travel to arrive at home simultaneously with, or preferably just prior to, the expected arrival of the truck.

This predictive notification system can also be used in other environments. For example, taxis and airport transportation vehicles could utilize this feature so that the client is notified before the vehicle reaches them. This would reduce lost time and gas consumption.

The present invention also has utility in the hotel industry. Major hotels may choose to utilize this system for use in conjunction with their airport shuttle service. In this scenario, the hotel manager would be alerted that the hotel shuttle is within a certain distance of the hotel. This would allow the manager to insure that there were sufficient hotel personnel in the reception area to respond to the influx of new customers.

What is claimed:

1. A method for notifying a user of the imminent arrival of a vehicle comprising:
providing a remote processor having access to predetermined user information comprising a location associated with said user;
providing a GPS-enabled device in said vehicle;
transmitting from said device to said processor vehicle location information;
computing in said server a value responsive to said transmitted location information;
comparing said computed value to said stored user information; and
sending an alert to said user based on said comparison.

2. The method of claim 1 wherein said vehicle location information is transmitted at regular intervals.

3. The method of claim 2 wherein said regular intervals are based on distance traveled.

4. The method of claim 2, wherein said regular intervals are based on elapsed time.

5. The method of claim 1, wherein said GPS-enabled device is a portable telephone.

6. The method of claim 1, wherein said alert is a text message sent to the portable telephone of said user.

7. the method of claim 1, wherein said alert is an instant message or email message sent to a personal computer of said user.

8. The method of claim 1, wherein said stored information comprises the location of said user.

9. The method of claim 1, wherein said stored information comprises the location of said user's designated bus stop.

10. The method of claim 1, wherein said stored information comprises the notification criteria for said user.

11. The method of claim 10, wherein said notification criteria comprise a predetermined distance from said user's location.

12. The method of claim 10, wherein said notification criteria comprise a predetermined distance from said user's designated bus stop.

13. The method of claim 10, wherein said notification criteria comprise a specific vehicle location.

14. The method of claim 10, wherein said notification criteria comprise a predetermined time from said user's location.

15. The method of claim 10, wherein said notification criteria comprise a predetermined time from said user's designated bus stop.

16. The method of claim 13, wherein said specific location is a scheduled vehicle stop.

17. The method of claim 1, wherein said stored information can be modified by said user.

18. The method of claim 17, wherein said modification is performed using a mobile phone, a telephone or via the internet.

19. A system for notifying a user to an imminent vehicle arrival comprising:
a GPS-enabled device, located in said vehicle, adapted to wirelessly transmit vehicle location information to a computing system;
storage means for storing information about said user;
said computing system for computing a value responsive to said transmitted vehicle location information and comparing said computed value to said stored user information; and
means for notifying said user based on said comparison.

20. The system of claim 19, wherein said GPS-enabled device is a portable telephone.

21. The system of claim 19, further comprising a portable telephone, wherein said notification is a text message sent to said portable telephone.

22. The system of claim 19, wherein said stored information comprises the location of said user.

23. The system of claim 19, wherein said stored information comprises the notification criteria for said user.

24. The system of claim 23, wherein said notification criteria comprise a predetermined distance from said user's location.

25. The system of claim 23, wherein said notification criteria comprise a predetermined distance from said user's designated bus stop.

26. The system of claim 23, wherein said notification criteria comprise a specific vehicle location.

27. The system of claim 23, wherein said notification criteria comprise a predetermined time from said user's location.

28. The system of claim 23, wherein said notification criteria comprise a predetermined time from said user's designated bus stop.

29. The system of claim 26, wherein said specific vehicle location is a scheduled vehicle stop.

30. A method of assuring the arrival of at least one object to a location at about the same time as or at a time prior to the arrival of a second object to said same location, comprising:
providing a database that sets forth an association of said at least one object with said same location;
providing a remote processor having access to said database;
providing said second object with a GPS-enabled device;
transmitting from said device to said processor the real time location of said second object;
computing a value responsive to said real time location;
comparing said association with said same location to said computed value; and
notifying said at least one object based on said comparison.

31. The method of claim 30, wherein there is a plurality of objects associated with said same location.

32. The method of claim 30, wherein said object is a student, said same location is a bus stop, said second object is a school bus and wherein said association of said at least one object with said same location is that said bus stop is said student's designated bus stop.

33. The method of claim 31, wherein said plurality of objects is a plurality of students, said same location is a bus stop, and wherein said association is that said bus stop is the designated bus stop common to each of said plurality of students.

34. The method of claim 30, wherein said association of said at least one object with said same location is the location of said second object relative to said same location.
